(19) United States
(12) Patent Application Publication
(10) Pub. No.: US 2002/0021344 A1
(43) Pub. Date: Feb. 21, 2002

(54) Image forming device

(76) Inventor: Per Klockar, Torslanda (SE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/878,163

(22) Filed: Jun. 8, 2001

Related U.S. Application Data
(63) Continuation of application No. PCT/SE98/02296, filed on Dec. 11, 1998.

(51) Int. Cl. G11B 3/00

(52) U.S. Cl. 347/112

(57) ABSTRACT

An image forming apparatus is provided in which a printhead structure is held in contact with the outer surface of a toner carrier, the contact force therebetween being maintained constant and relatively low, notwithstanding mechanical variations of the toner carrier. The contact surface between the toner carrier and the printhead structure is preferably located in the vicinity of the apertures in order to ensure a constant gap distance between the apertures and a toner layer carried on the outer surface of the toner carrier.

### RELATED APPLICATIONS

The present application is a continuation of International Application No. PCT/SE98/02296, filed on Dec. 11, 1998, which designates the United States Patent and Trademark Office as a designated office and as an elected office, and the present application claims the benefit of priority under 35 U.S.C. §120 of International Application No. PCT/SE98/02296, which is incorporated by reference herein.

### BACKGROUND OF THE INVENTION

1. Field of the Invention

The present invention is within the field of electrographical printing devices. More specifically, the invention relates to an image forming apparatus including an apertured printhead structure brought into cooperation with a particle source to modulate a stream of toner particles from the particle source through the apertured printhead structure. The invention further relates to improved means for accurately positioning the printhead structure in relation to the particle source to maintain a constant gap distance therebetween.

2. Description of the Related Art

U.S. Pat. No. 5,036,341 granted to Larson discloses a direct electrostatic printing device and a method to produce text and pictures with toner particles on an image receiving substrate directly from computer generated signals. The Larson patent discloses a method in which an electrode matrix, arranged between a back electrode and a rotating particle carrier, generates a pattern of electrostatic fields which, due to control in accordance with an image information, modulate a transport of toner particles toward the back electrode. An electrostatic field on the back electrode attracts the toner particles from the surface of the particle carrier to create a particle stream toward the back electrode. The particle stream is modulated by voltage sources which apply an electric potential to selected individual control electrodes to create electrostatic fields which either permit or restrict the transport of toner particles from the particle carrier through the electrode matrix. In effect, these electrostatic fields “open” or “close” either permit or restrict the transport of toner particles from the particle carrier through the electrode matrix. In effect, these electrostatic fields “open” or “close” selected apertures in the electrode matrix to the passage of toner particles by influencing the attractive force from the back electrode. The modulated stream of charged toner particles allowed to pass through the opened apertures impinges upon a print-receiving medium interposed in the particle stream to provide line-by-line scan printing to form a visible image.

An electrode matrix for use in direct electrostatic printing devices may take on many designs, such as a lattice of intersecting wires arranged in rows and columns, or a screen-shaped, apertured printed circuit. Generally, the matrix is formed of a thin, flexible substrate of electrically insulating material, such as polyimide, provided with a plurality of apertures and overlaid with a printed circuit of control electrodes arranged in connection to the apertures, such that each aperture is surrounded by an individually addressable control electrode.

An essential requirement of the aforementioned method is to maintain a constant, uniform gap distance between the control electrodes and the toner particle layer on the particle carrier. The gap distance can vary from machine to machine because it is determined by a combination of independent factors such as manufacturing variations in the size and placement of the particle carrier and the electrode matrix, as well as the thickness of the toner layer on the particle carrier. Because the gap distance is only in the order of 10-30 microns, even the slightest mechanical imperfections can result in a drastic degradation of the print quality. For instance, the particle carrier is a rotating cylinder having a rotation axis which is not perfectly centered, or an outer surface which is neither perfectly round nor perfectly smooth, along which various surface imperfections cause variation in the gap distance. Further, the toner particles themselves may vary in their diameter and degree of sphericity, and the toner particle layer may vary in thickness along the surface of the cylinder. Thus, to accommodate all of these independent dimensional variations, there is a need for improved means for positioning a printhead structure in conjunction to a particle source.

U.S. Pat. No. 5,552,814 discloses an apparatus comprising a biasing device by which corresponding portions of the particle carrier and the printhead structure which are adjacent to the apertures are biased against each other for contact therebetween. In such an apparatus, the printhead structure preferably comprises an elastic substrate made of electrically insulating material so that the control electrodes are formed on one surface of the substrate. The biasing device may include tensioning means for applying a tension to the printhead structure so that the printhead structure is held elastically curved along a part of the outer surface of the toner carrier such that the printhead structure is in pressing contact with the toner carrier. The tensioning means are used to apply a tension on the printhead structure in a direction of feed of the recording medium. A drawback associated with a biasing device such as that disclosed in U.S. Pat. No. 5,552,814 is that variations in the relative position between the toner carrier and the printhead structure considerably influence the contact force therebetween. For example, if the toner carrier is not perfectly centered about its rotation axis, the contact force will vary along the outer surface of the toner carrier, causing a degradation of the print uniformity. Moreover, the surface of the printhead structure facing the toner carrier is worn away or deteriorated by abrasion forces due to frictional contact with toner particles. This may result in higher friction coefficient and higher surface roughness of the printhead structure, which in turn degrades the toner layer supplied to the apertures.

Therefore, there is still a need to improve means for positioning a printhead structure in conjunction to a toner carrier, so as to ensure a relatively low and constant contact force therebetween, that contact force being independent of mechanical imperfections or manufacturing variations of the toner carrier.

### SUMMARY OF THE INVENTION

It is therefore an object of the present invention to provide an image forming apparatus in which a printhead structure is held in contact with the outer surface of a toner carrier, the contact force therebetween being maintained constant and relatively low, notwithstanding mechanical variations of the toner carrier. The contact surface between the toner carrier and the printhead structure is preferably located in the vicinity of the apertures in order to ensure a constant gap distance between the apertures and a toner layer carried on the outer surface of the toner carrier.

According to the present invention, the printhead structure comprises a sheet-like substrate of flexible material, such as polyimide or the like, having a substantially rectangular shape, a first surface facing the toner carrier, a second surface facing the recording medium, a longitudinal axis in the feed direction of the recording medium, a transversal axis extending perpendicular to the feed direction of the recording medium, a front part located downstream of the transversal axis with respect to a feed direction of the recording medium, a rear part located upstream of the transversal axis with respect to a feed direction of the recording medium, and a plurality of apertures aligned in at least one row extending preferably parallel with the transversal axis.

Portions of the front and rear parts of the substrate are coated with a film of rigid material, so that the substrate has a variable flexibility along its longitudinal axis. Accordingly, the substrate has a first rigid portion on its front part, a second rigid portion on its rear part, and a bendable portion therebetween, in the following referred as free portion. One of said front and rear parts of the substrate is transversally fastened along a fastening line by means of a securing device, and the opposite part is supported at a supporting point by means of a supporting device. The fastening line and the supporting point are positioned on each side of the toner carrier in such an arrangement that the substrate is held arcuate along its longitudinal axis so that the free portion of the substrate which contacts the outer surface of the toner carrier has a curvature radius substantially equal to the radius of the toner carrier.

### BRIEF DESCRIPTION OF THE DRAWINGS

FIG. 1 is a schematic view of an image forming apparatus according to the present invention,

FIG. 2a is a schematic section view across a print station of the image forming apparatus of FIG. 1,

FIG. 2b is an enlargement of a part of FIG. 2a, showing a print zone in a print station,

FIG. 3a is a schematic plane view of a printhead structure in an image forming apparatus as that shown in FIG. 1,

FIG. 3b is an enlargement of a part of FIG. 3a,

FIG. 4 is a schematic perspective view of a printhead structure and its position in a print station,

FIG. 5 is a schematic section view of the printhead structure of FIG. 4, across the longitudinal axis thereof,

FIG. 6 is a schematic view of conventional positioning of a printhead structure in an image forming device according to prior art,

FIG. 7 is a schematic view of positioning of a printhead structure in an image forming device according to the present invention,

FIG. 8 is an embodiment of the positioning of a printhead structure in conjunction to a toner carrier,

FIG. 9 is another embodiment of the positioning of a printhead structure in conjunction to a toner carrier,

FIG. 10 is another embodiment of the positioning of a printhead structure in conjunction to a toner carrier, in which spacer means are provided to maintain a constant gap distance therebetween,

FIG. 11 is an embodiment of the present invention in which the printhead structure is arranged on a mounting frame.

### DETAILED DESCRIPTION OF THE PREFERRED EMBODIMENT

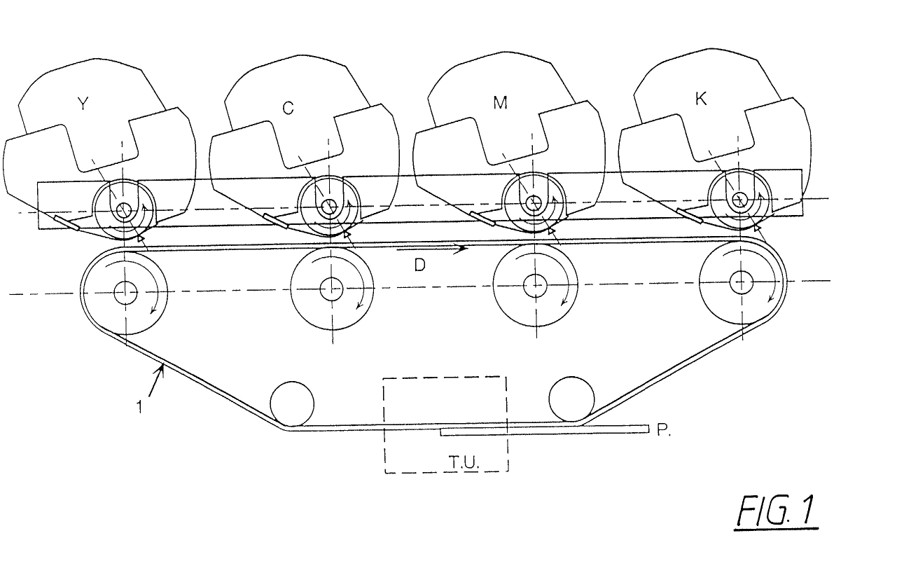

1. General Description of the Apparatus Referring to FIG. 1

The present invention relates to an image recording apparatus such as that schematically illustrated in FIG. 1, in which an image receiving medium, such as an intermediate transfer belt 1, is conveyed in a longitudinal direction (arrow D) successively past four print stations (Y, C, M, K), each corresponding to a specific toner color (generally yellow, cyan, magenta and black), to intercept a modulated stream of toner particles from each print station whereby the so obtained four image configurations are directly superposed onto the transfer belt 1, forming a visible four color toner image. That toner image is subsequently brought into contact with an information carrier (P) in a transfer unit (TU), whereas the toner image is transferred to the information carrier and thereafter made permanent in a fusing unit (not shown).

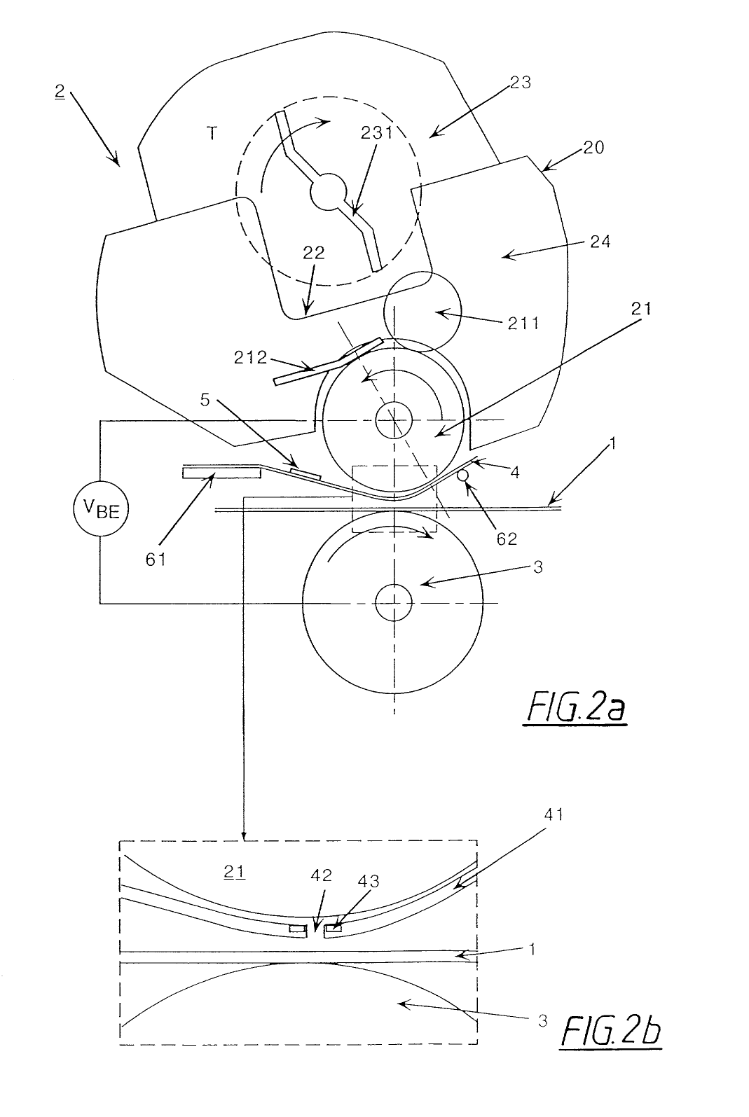

2. General Description of a Print Station Referring to FIGS. 2a and 2b

A print station includes:

(a) a particle delivery unit 2 for conveying charged pigment particles to a position adjacent to the image recording medium 1, said particle delivery unit 2 including a particle carrier 21;

(b) a background electrode 3 positioned in conjunction with the particle carrier 21;

(c) a background voltage source VBE for producing a background electric field between said background electrode 3 and said particle carrier 21, which background electric field enables a transport of charged pigment particles from the particle carrier 21 toward the background electrode 3;

(d) a printhead structure 4 positioned in said background electric field between the toner carrier 21 and the background electrode 3, said printhead structure 4 including: a substrate 41 of electrically insulating material; a plurality of apertures 42 arranged through the substrate 41; and control electrodes 43 arranged in conjunction with the apertures 42;

(e) variable voltage sources 5 connected to said control electrodes 43 to produce a pattern of electrostatic control fields influencing said background electric field in accordance with an image information for selectively permitting or restricting said transport of charged pigment particles through the apertures 42; and

(f) a positioning device for positioning the printhead structure 4 in relation to the particle carrier 21, including a fastening element 61 and a supporting element 62.

3. General Description of the Different Parts of the Print Station

(a) The particle delivery unit 2 (as shown in FIG. 2a) includes a casing 20, a partition 22 which separates the casing 20 into a toner container 23 for storing toner particles T, and a buffer chamber 24 for regulation of the amount of toner to be supplied. Provided in the toner container 23 is a rotating stirring member 231 for supplying toner from the toner container 23 to the buffer chamber 24. The buffer chamber 24 includes a rotating, substantially cylindrical toner carrier 21 having a transversal rotation axis, a predetermined radius R and a peripheral outer surface on which a toner layer is formed by means of a supply element 211 for delivering toner to the toner carrier, and a regulation element 212 which ensures a uniform toner layer thickness.

(b) The background electrode 3 (as shown in FIG. 2a) is a rotating, substantially cylindrical roller supporting the image transfer belt 1. The background electrode roller 3 has a transversal rotation axis.

(c) The background voltage source V_{BE} (as shown in FIG. 2a) produces an electric potential difference between the particle carrier 21 and the back electrode roller 3 for generating a uniform background electric field therebetween, which exposes the toner layer for an attraction force toward the background electrode roller 3 thereby enabling a toner transport through the selected apertures 42. The electric potential difference can be in the order of +1500 V.

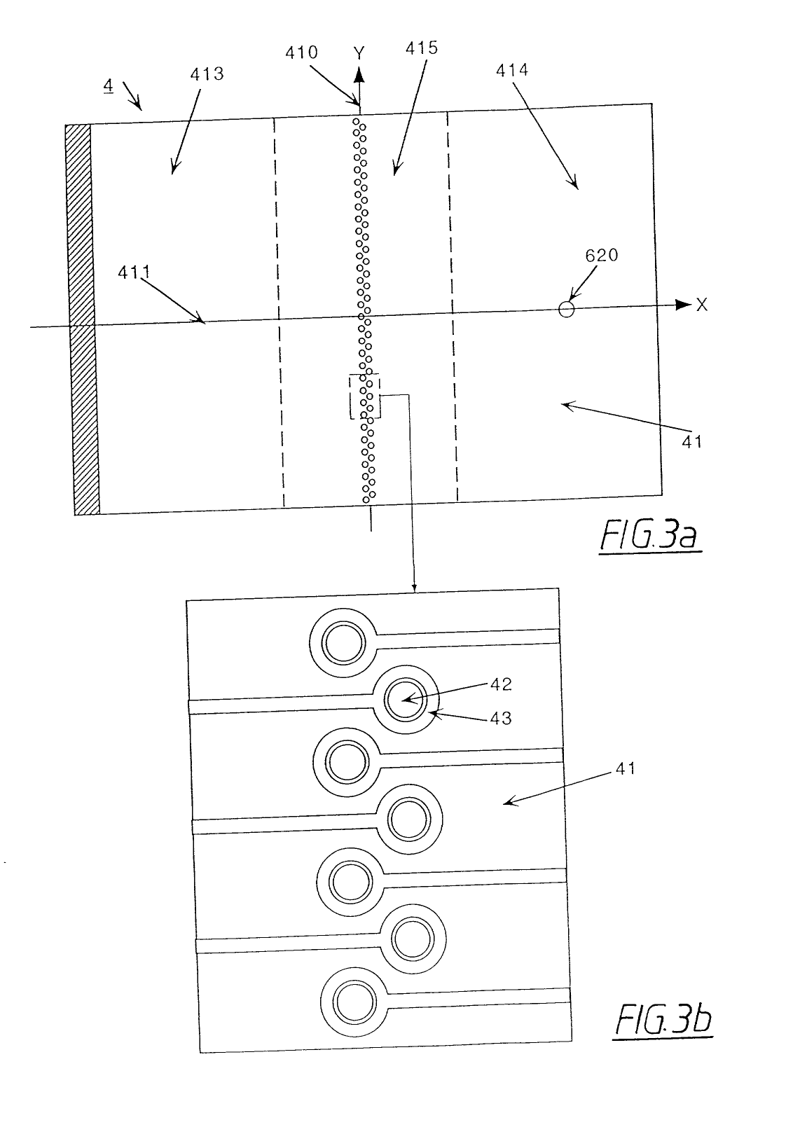

(d) The printhead structure 4 (as shown in FIGS. 3a and 3b) includes a sheet-like substrate 41 of electrically insulating, flexible polymer material, such as polyimide or the like, having a substantially rectangular shape with a transversal axis 410 along the Y-axis and a longitudinal axis 411 parallel to the X-axis. The substrate 41 has a predetermined thickness, a first surface facing the particle carrier 21, a second surface facing the background electrode roller 3, a front part 413 located upstream of the transversal axis 410 with respect to the rotation of the particle carrier 21, and a rear part 414 located downstream of the transversal axis 410 with respect to the rotation of the particle carrier 21. The printhead structure 4 has a plurality of apertures 42 arranged through the substrate 41 and aligned in at least one transversal row, for example extending along the transversal axis 410. The first surface of the substrate is overlaid with a first printed circuit including a plurality of control electrodes 43 each of which surrounds a corresponding aperture 42 in the substrate. The first printhead circuit is coated with a first cover layer (not shown) of electrically insulating material.

According to a preferred embodiment of the present invention, the front and rear parts 413, 414 of the substrate 41 are at least partially laminated with a thin sheet of rigid material. A central portion 415 of the substrate 41, located between the front part 413 and the rear part 414 remains unlaminated and thus flexible. The apertures 43 are arranged on the flexible central portion 415 of the substrate 41. Accordingly, the substrate 41 has a variable flexibility along its longitudinal axis 411, such that the central portion 415 can be given an arcuate shape following the curvature of the particle carrier 21.

(e) The variable voltage sources (not shown) are generally conventional IC-drivers supplying a stream of control voltage pulses, defining an image information, to the control electrodes for electrostatically opening or closing corresponding apertures in the substrate, so as to permit or restrict the influence of the background electric field on the toner layer through the opened apertures, and thus modulate a selective toner transport through the printhead structure toward the background electrode. The control voltage pulses have a magnitude and a pulse-width dimensioned to control the amount of toner particles allowed to pass through the corresponding aperture during a print sequence.

(f) The positioning device (as shown in FIG. 2a) includes a fastening element 61 for securing the front part of the substrate to the particle delivery unit along a transversal fastening line, and a supporting element 62 for supporting the rear part of the substrate at a predetermined supporting point 620 on the longitudinal axis of the substrate.

4. General Description of the Invention

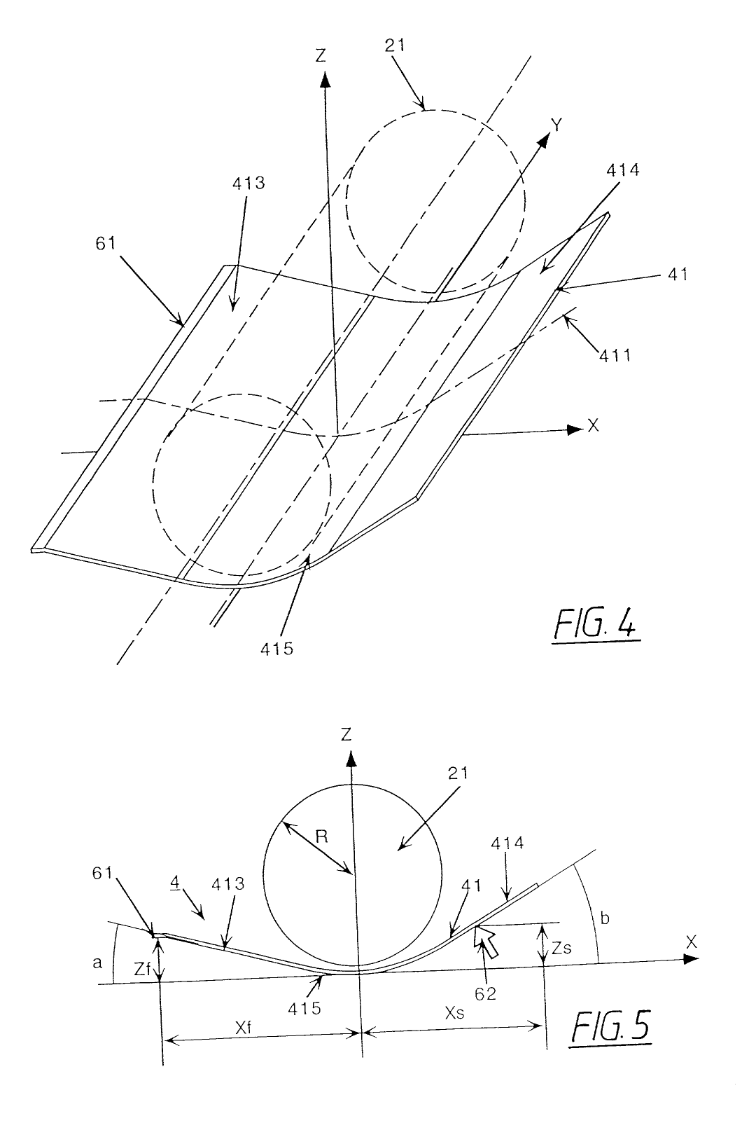

The position of the printhead structure 4 relative to the particle carrier according to a preferred embodiment of the present invention is schematically illustrated in FIG. 4 and FIG. 5.

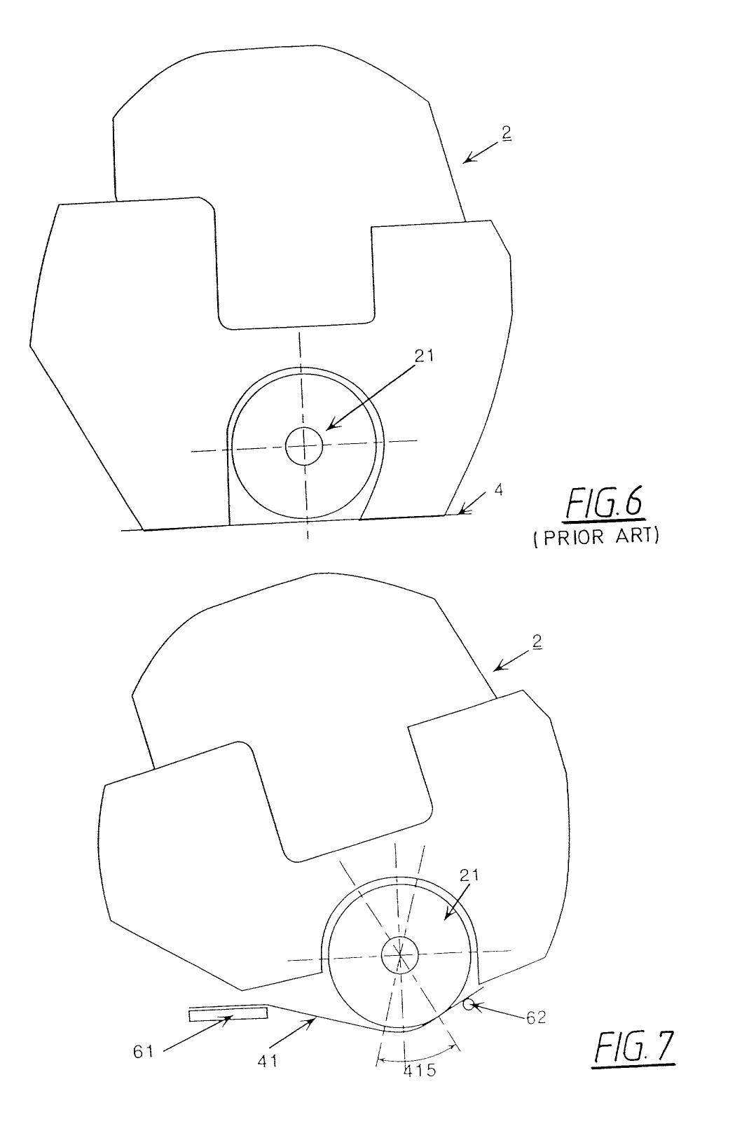

According to most prior art (FIG. 6), the printhead structure is conventionally positioned on a X-Y plane and arranged between two transversally extending fastening elements which maintains the substrate in a stretched state at a predetermined gap distance from the peripheral outer surface of the particle carrier. According to the present invention, a fastening element 61 extends transversally across the width of the substrate 41 at a predetermined distance Zf from the X-Y plane and at a predetermined distance Xf from the Y-Z plane. The securing element 62 is preferably disposed to support the substrate 41 at a predetermined position on its longitudinal axis 411. The supporting element 62 is arranged at a predetermined distance Zs from the X-Y plane and at a predetermined distance Xs from the Y-Z plane. Front and rear parts 413, 414 of the substrate 41 are. made rigid, whereby only the central part 415 of the substrate 41 is allowed to be bent. Accordingly, the rigid parts of the substrate 41 will extend at angles a and b from the X-Y plane, which in turn results in a curvature of the central flexible part 415 of the substrate 41. That curvature is determined by the distances Xf, Zf, Xs, Zs which are adapted to the radius R of the particle carrier 21. Since the substrate 41 is supported at a single point, the whole printhead structure is allowed to pivot in both longitudinal and transversal direction in order to accommodate the mechanical variations of the particle carrier.

5. Embodiments of the Invention

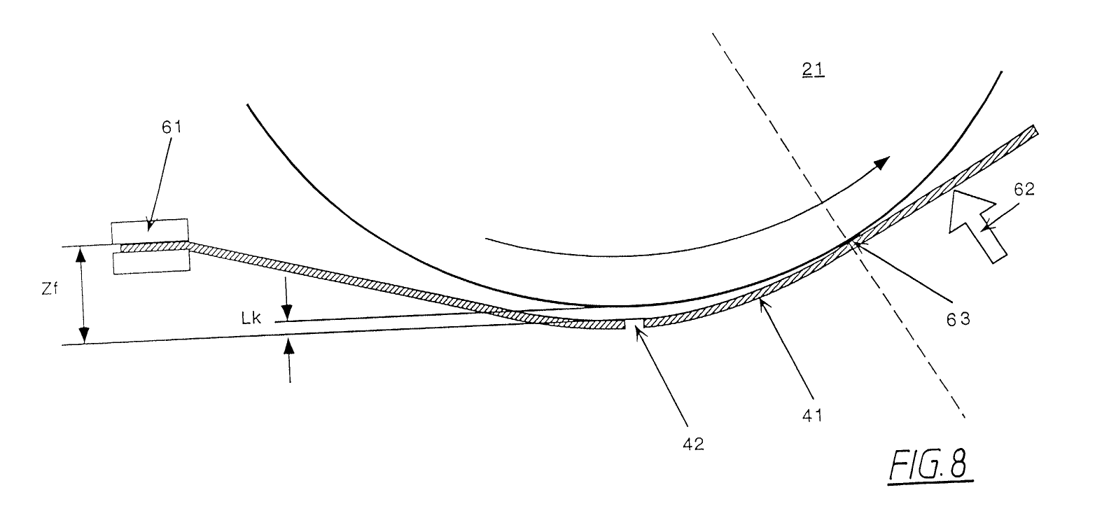

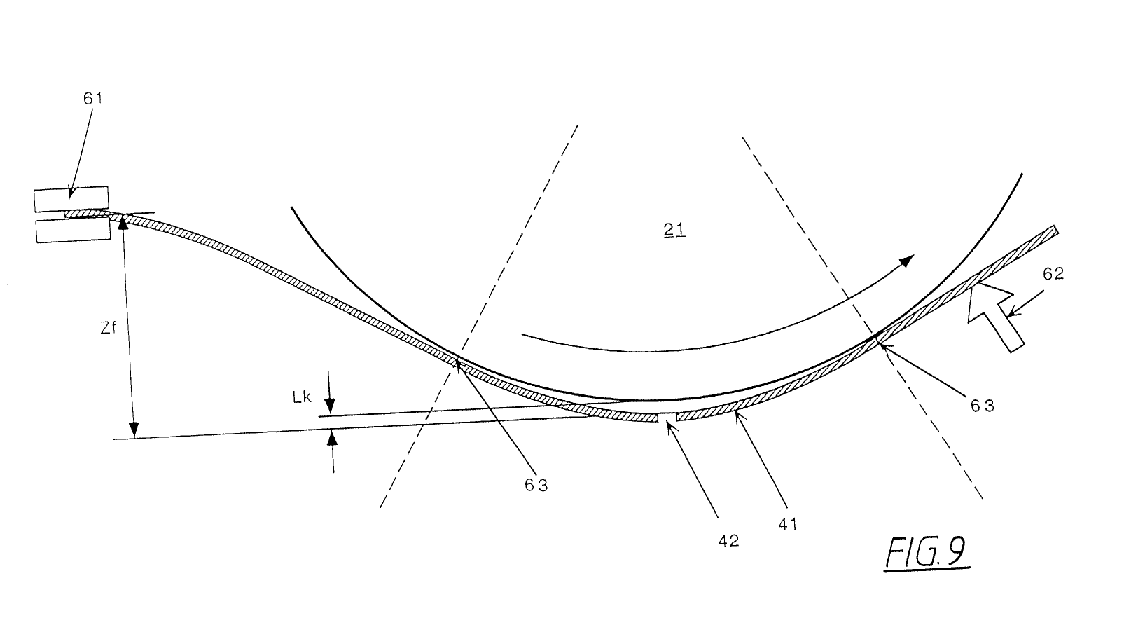

Shown in FIGS. 7 and 8 is an embodiment of the invention in which the fastening and supporting elements 61, 62 are disposed so as to provide a contact area 63 between the peripheral outer surface of the particle carrier 21 and the first surface of the substrate 41. The contact area 63 is located between the apertures 42 and the supporting element 62, downstream of the apertures 42 with respect to the rotation of the particle carrier 21. The curvature radius of the substrate 41 is made slightly larger than the radius R of the particle carrier 21, which results in a uniform gap distance Lk between the apertures 42 and the peripheral outer surface of the particle carrier 21. Since the substrate 41 is held in contact with the particle carrier 21, the substrate 41 follows the shape of the particle carrier 21, resulting in that the gap distance Lk remains constant and independent of undesired mechanical variations. The supporting element 62 maintain the substrate 41 in contact with the particle carrier 21 along a transversal contact line onto the peripheral outer surface thereof, and allows the substrate 41 to pivot in order to compensate both radial and transversal variations of the shape of the particle carrier 21. Accordingly, the pivotability of the substrate 41 ensures a uniform gap distance Lk even when the particle carrier 211 is not perfectly centered, nor perfectly parallel to the X-Y plane.

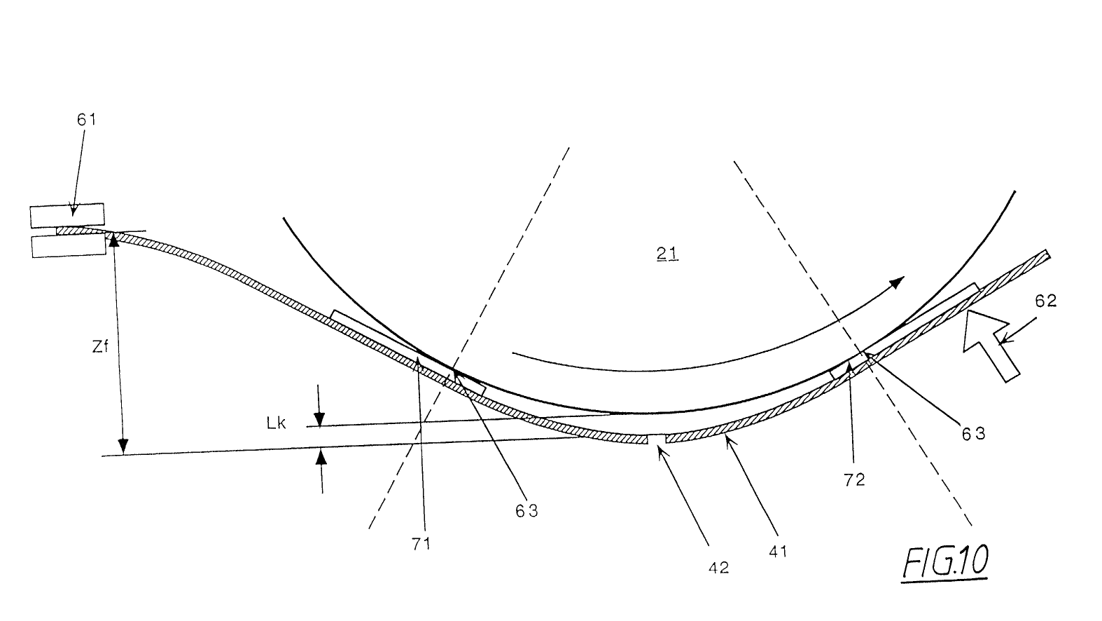

Shown in FIG. 9 is an embodiment of the invention, in which the curvature of the substrate 41 is dimensioned to provide a contact area 63 on both sides of the apertures 42. The curvature radius of the substrate between the contact areas is slightly smaller than the radius of the particle carrier 21, resulting in that a uniform gap distance Lk is formed between the peripheral outer surface of the particle carrier and the apertures.

Shown in FIG. 10 is an alternate embodiment of the invention including spacer layers 71, 72 arranged between the substrate 41 and the particle carrier 21. In such an embodiment the gap distance Lk is mainly determined by a predetermined thickness of a spacer layer 71 arranged upstream of the apertures 42 with respect to the rotation of the particle carrier. Preferably, the positioning device includes an upstream spacer layer 71 interposed between the front part 413 of the substrate 41 and the peripheral outer surface of the particle carrier 21. Spacer layers 71, 72 may also be arranged on both upstream and downstream positions as exemplified in FIG. 10. The spacer layer 71 is preferably a removable sheet of flexible material, such as polyimide, having a predetermined thickness corresponding to an appropriate value of the gap distance Lk.

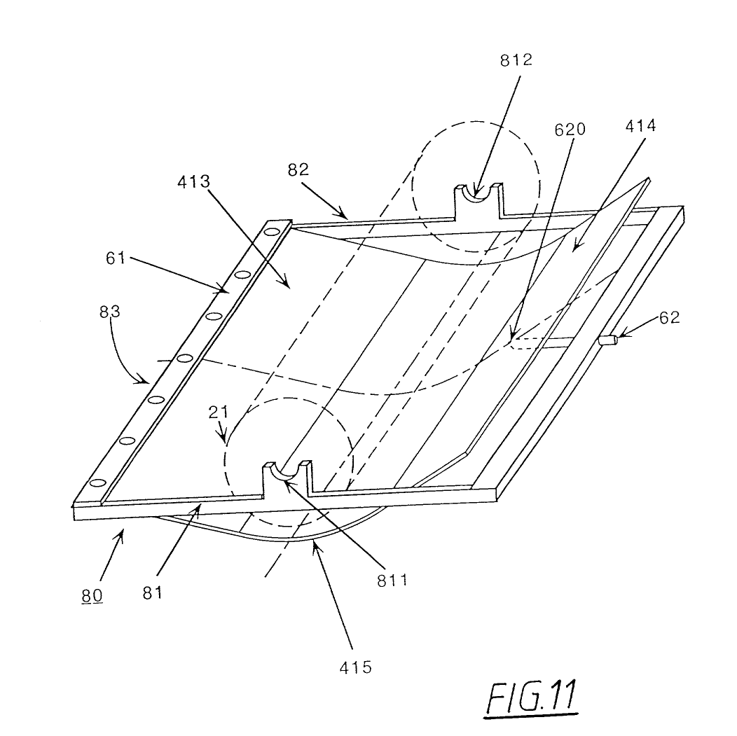

A positioning device in accordance to the present invention may be constructed as shown in FIG. 11. A mounting frame 80 is arranged in a position parallel to the X-Y plane of FIGS. 4, 5. The mounting frame 80 has two longitudinal portions 81, 82 having elements 811, 812 for supporting the particle carrier 21, a first transversal portion 83 on which the substrate 41 is fastened by the fastening element 61, and a second transversal portion 84 in which a supporting element 62 is arranged. As shown in FIG. 11, the supporting element 62 is an adjustable pivot having a first end brought in contact with the substrate. The pivot can be adjusted, for example moved in a X-direction, in order to accurately optimize the contact point 620 on the substrate 41, thereby even the curvature of the substrate 41. In that example, the fastening element 61 may by a metal ruler saving a plurality of holes. An edge of the substrate 41 is interposed between the first transversal portion 83 of the mounting frame 80 and the ruler 61.

One of the advantages of such a construction, compared with conventional mounting frames, is that the substrate, being only fastened at one end, is allowed to vibrate during the print process. That vibration contributes to dislodge toner particles agglomeration from the apertures, ensuring a uniform printing without clogging.

What is claimed is:

1. An image recording apparatus for forming an image on an image recording medium, said apparatus including:
a particle delivery unit for conveying charged pigment particles to a position adjacent to the image recording medium, said particle delivery unit including a particle carrier;
a background electrode positioned in conjunction with the particle carrier;
a background voltage source for producing a background electric field between said background electrode and said particle carrier, which background electric field enables a transport of charged pigment particles from the particle carrier toward the background electrode;
a printhead structure positioned in said background electric field between the toner carrier and the background electrode, said printhead structure including:
a substrate of electrically insulating material;
a plurality of apertures arranged through the substrate; and
control electrodes arranged in conjunction with the apertures;
variable voltage sources connected to said control electrodes to produce a pattern of electrostatic control fields influencing said background electric field in accordance with an image information for selectively permitting or restricting said transport of charged pigment particles through the apertures; and
a positioning device for positioning the printhead structure in relation to the particle carrier, said positioning device comprising a fastening element and a support element, wherein:
said substrate comprises at least a flexible portion, a first part which is fastened in a fixed position by means of said fastening element, and a second part which is supported by said supporting element in such a position, that said flexible portion is maintained in an arcuate shape around a portion of an outer surface of the particle carrier.

2. An image forming apparatus as defined in claim 1, in which:
the particle carrier is a rotating, substantially cylindrical roller having a rotation axis, a predetermined radius and a peripheral outer surface; and
the substrate of the printhead structure has a first surface facing the outer surface of the particle carrier, a second surface facing the background electrode, a transversal axis extending parallel with the rotation axis of the particle carrier;
wherein
the first surface of the substrate is maintained in contact with the peripheral outer surface of the particle carrier at at least one predetermined contact surface.

3. An image forming apparatus as defined in claim 2, in which the contact surface is located downstream of said transversal axis with respect to the rotation direction of the particle carrier.

4. An image forming apparatus as defined in claim 2, in which the contact surface is located upstream of said transversal axis with respect to the rotation direction of the particle carrier.

5. An image forming apparatus as defined in claim 2, in which a first contact surface and a second contact surface are located upstream and downstream of said transversal axis with respect to the rotation direction of the particle carrier, respectively.

6. An image forming apparatus as defined in claim 2, in which the apertures are aligned in at least one row extending parallel with said transversal axis.

7. An image forming apparatus as defined in claim 2, in which said flexible portion of the substrate is held in an arcuate shape along a segment of the peripheral outer surface of the particle carrier.

8. An image forming apparatus as defined in claim 2, in which said flexible portion of the substrate is held in an arcuate shape having a curvature radius equal to or larger than said radius of the particle carrier.

9. An image forming apparatus as defined in claim 2, in which the substrate has a front part located upstream of said transversal axis with respect to a rotation direction of the particle carrier, a rear part located downstream of said transversal axis with respect to a rotation direction of the particle carrier, and a central part located therebetween wherein:
said front part is fastened by said fastening element along a fastening line extending parallel to said transversal axis, said rear part of the substrate is supported by said supporting means at a predetermined supporting point and said central part is held in an arcuate shape along a segment of the peripheral surface of the particle carrier.

10. An image forming apparatus as defined in claim 9, in which the front and rear parts of the substrate are rigid and the central part is flexible.

11. An image forming apparatus as defined in claim 9, in which the whole substrate is made of flexible material and the front and rear parts are lamninated with a rigid material.

12. An image forming apparatus as defined in claim 9, in which an upstream spacer layer is interposed between said front part of the substrate and the peripheral outer surface of the particle carrier.

13. An image forming apparatus as defined in claim 9, in which a downstream spacer layer is interposed between said rear part of the substrate and the peripheral outer surface of the particle carrier.

14. An image forming apparatus as defined in claim 9, in which an upstream spacer layer is interposed between said front part of the substrate and the peripheral outer surface of the particle carrier and a downstream spacer layer is interposed between said rear part of the substrate and the peripheral outer surface of the particle carrier.

15. An image forming apparatus as defined in claim 12, in which the upstream spacer layer is a sheet of flexible material having a predetermined thickness dimensioned to space the apertures of the substrate from the peripheral outer surface of the particle carrier.

16. An image forming apparatus as defined in claim 1, further including a mounting frame having a first transversal wall and a second transversal wall, in which a first part of the substrate is fastened to said first transversal wall by means of the fastening element, and the supporting element is arranged in the second transversal wall for supporting a second part of the substrate at a predetermined supporting point.

17. An image forming apparatus as defined in claim 16, in which the position of the supporting point is controlled by adjusting the supporting element, thereby controlling the curvature of the flexible portion of the substrate.

18. An image forming apparatus as defined in claim 13, in which the downstream spacer layer is a sheet of flexible material having a predetermined thickness dimensioned to space the apertures of the substrate from the peripheral outer surface of the particle carrier.

19. An image forming apparatus as defined in claim 14, in which each of the upstream spacer layer and the downstream spacer layer comprises a sheet of flexible material having a predetermined thickness dimensioned to space the apertures of the substrate from the peripheral outer surface of the particle carrier.
